(19) United States
(12) Patent Application Publication
(10) Pub. No.: US 2009/0318144 A1
(43) Pub. Date: Dec. 24, 2009

(54) CELLULAR COMMUNICATION SYSTEM AND METHOD OF OPERATION THEREFOR

(75) Inventors: Howard J. Thomas, Cirencester (GB); Gerard T. Foster, Marston Meysey (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/478,004

(22) Filed: Jun. 4, 2009

(30) Foreign Application Priority Data
Jun. 19, 2008 (GB) 0811282.3

(51) Int. Cl. H04W 48/20; H04W 36/00

(52) U.S. Cl. 455/434; 455/437

(57) ABSTRACT

A cellular communication system comprises a first base station (103) supporting user equipments (101) in a first cell. A user equipment (101) is supported in the first cell by the first base station (103) and is arranged to transmit previous cell switch candidate data to the first base station (103). The previous cell switch candidate data comprises an indication of at least one cell switch candidate for at least one base station supporting the user equipment prior to the first base station (103). The first base station is arranged to receive the previous cell switch candidate data transmitted from the user equipment (101). The previous cell switch candidate data may be used for different purposes such as synchronization of cells or generation of suitable cell switch candidate lists, such as neighbour cell lists. In particular, the approach may allow an improved automated or semi-automated generation of neighbour cell lists for a dynamically changing cell layout.

### FIELD OF THE INVENTION

The invention relates to a cellular communication system and a method of operation therefor and in particular, but not exclusively, to a heterogeneous cellular communication system.

### BACKGROUND OF THE INVENTION

Cellular communication systems including 2^{nd} and 3^{rd} generation cellular communication systems, such as the Global System for Mobile communication (GSM) and the Universal Mobile Telecommunication System (UMTS), as well as wireless area networks such as IEEE 802.xx systems (including Wireless Local Area Networks (WLANs), Wireless Metropolitan Area Networks (WMANs) etc) have become increasingly widespread and popular.

Although many cellular systems were originally designed as single stand alone systems with well defined components, network architectures, data protocols and communication services, there is an increasing tendency to integrate and combine different systems and communication services. For example, there is an increasing focus on enabling the interworking of different communication systems and in particular it is desired that a multi-system terminal will be able to seamlessly switch between different communication systems for ongoing calls or data sessions.

Furthermore, whereas cellular communication systems were originally relatively simple and relatively inflexible systems supporting relatively limited and well known services, architectures, cell plans and configurations, there is a trend towards an increasing flexibility and adaptability of the systems both in terms of the provided service characteristics and in terms of the continuous operation and management. For example, a flexible and easy adaptation of different deployed cell configurations is desired.

As an example, neighbour cell information is typically transmitted from the base stations of a cellular communication system in order to allow user equipments to identify and monitor suitable handover and cell reselection candidates for the current cell. Traditionally, such neighbour lists have been generated as part of a relatively rare frequency planning process with the neighbour lists being centrally generated for each individual cell in response to the determined cell configuration. The neighbour lists are then communicated to the individual base stations for broadcasting. However, such an approach results in a relatively complex centralised neighbour list control and management system.

In many cellular systems, it is increasingly desired that new cell configurations may be dynamically deployed in an ad-hoc and distributed manner. In particular, it has been proposed that underlay cells such as pico-cells or femto-cells may be dynamically and flexibly introduced to a micro-and macro-cell overlay without requiring complex cell re-planning and reconfiguration. As the cell sizes of such base stations are typically very small and the frequency/code resource allocated to the base stations may be selected from a resource block specifically allocated to underlay cells (and thus being relatively isolated from the higher layers), the impact on the micro-cell and macro-cell layers may be negligible. Accordingly, the base stations may often be introduced without affecting the cell configurations (e.g. the frequency plan) for these layers. However, in order for the underlay cells to be effectively used, it is necessary for the neighbour lists allocated in the system to be updated to reflect the addition or removal of new underlay base stations/cells.

In order to provide facilitated reconfiguration and increased flexibility, it is desired that the system may automatically reconfigure itself to reflect the addition or removal of new base stations/cells. Thus, it is desired that the neighbour lists of all affected base stations are automatically updated and adapted to the new cell configuration. E.g. when a base station is removed, it is desired that this is automatically detected and that the base station is removed from the appropriate neighbour lists. Similarly, when a new base station is introduced, it is desired that the neighbour list for this base station is automatically created and that the new base station is automatically included in neighbour lists of the appropriate base stations from which a user equipment may handover to the new base station.

However, the current approaches tend to be inflexible, cumbersome, resource demanding and slow. In particular, the centralised approach of using a common central neighbour list management centre tends to be unsuitable for dynamically and automatically adapting to changed cell configurations and layouts. In particular, it tends to be impractical for a dynamic and flexible adaptation of neighbour cell lists on an ad-hoc basis.

For example, increasingly systems may include a plurality of different neighbour list management entities each of which manages the neighbour lists in only part of the system. However, as the different domains may not have information of neighbour cell planning in other parts of the system, it may not be practical or even feasible to use a conventional centralised neighbour list management approach.

In particular, for interoperation between different cellular communication systems there is typically no centralised neighbour list management entity controlling all systems. Therefore, it may not be practical or feasible to update neighbour lists of one system to reflect the addition or removal of a base station of another system. In particular, in order to achieve this using a traditional approach, a complex, cumbersome, resource demanding and inflexible interoperation between centralised neighbour list management entities of the different systems is often applied. Alternatively, intersystem handovers between the systems may be limited. For example, intersystem handovers may only be possible at the macro-cell layer thereby resulting in a reduced efficiency and suboptimal intersystem handover operation.

Another problem with effective neighbour list management in a dynamic system is that the optimal neighbour lists for the different cells depend on the actual radio environments experienced by the base stations which are typically difficult to determine and evaluate. Hence, an improved system would be advantageous and in particular a system allowing increased flexibility, facilitated implementation, improved adaptation to base station/cell reconfigurations, improved neighbour cell management and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a cellular communication system comprising: a first base station supporting user equipments in a first cell; a user equipment arranged to transmit previous cell switch candidate data to the first base station when supported in the first cell by the first base station; the previous cell switch candidate data comprising an indication of at least one cell switch candidate for at least one base station supporting the user equipment prior to the first base station; and wherein the first base station is arranged to receive the previous cell switch candidate data transmitted from the user equipment.

The invention may allow facilitated implementation and/or facilitated operation and/or improved performance in a cellular communication system. In particular, improved information of a cell configuration may be determined at a base station. Specifically, information may be obtained directly from the user equipment for not only cells that are cell switch candidates of the base station but also of cells/base stations that are themselves cell switch candidates of these. E.g. information may not only be obtained for neighbour cells but also for neighbour cells of neighbour cells. The approach may for example allow improved and/or facilitated discovery of possible handover or reselection targets for user equipments of different cells. The approach may in particular in many embodiments allow discovery and cell layout/configuration data to be communicated across different cell switch candidate management domains and may in particular facilitate and/or improve distribution of cell layout/configuration information across different communication systems. The approach may in particular facilitate and/or enable distribution and generation of cell relationship data which is useful for generating and/or updating cell switch candidate lists, such as neighbour lists. A cell switch candidate list for a base station may comprise a list of other cells which are potential handover or cell reselection targets for user equipments currently supported by the base station (e.g. in active or idle mode). The improved distribution of information may allow improved cell switch candidate lists resulting in improved cell switch operation for user equipments and thus improved performance of the communication system as a whole.

According to an aspect of the invention there is provided a user equipment for a cellular communication system including a first base station supporting user equipments in a first cell; the user equipment comprising: means for transmitting previous cell switch candidate data to the first base station when supported in the first cell by the first base station; the previous cell switch candidate data comprising an indication of at least one cell switch candidate for at least one base station supporting the user equipment prior to the first base station.

According to an aspect of the invention there is provided a method of operation for a cellular communication system including a first base station supporting user equipments in a first cell and a user equipment being supported in the first cell by the first base station; the method comprising: the user equipment transmitting previous cell switch candidate data to the first base station; the previous cell switch candidate data comprising an indication of at least one cell switch candidate for at least one base station supporting the user equipment prior to the first base station; and the first base station receiving the previous cell switch candidate data transmitted from the user equipment.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an example of a cellular communication system in accordance with some embodiments of the invention; and

FIG. 3 illustrates an example of a method of operation for a cellular communication system in accordance with some embodiments of the invention.

### DETAILED DESCRIPTION OF SOME EMBODIMENTS OF THE INVENTION

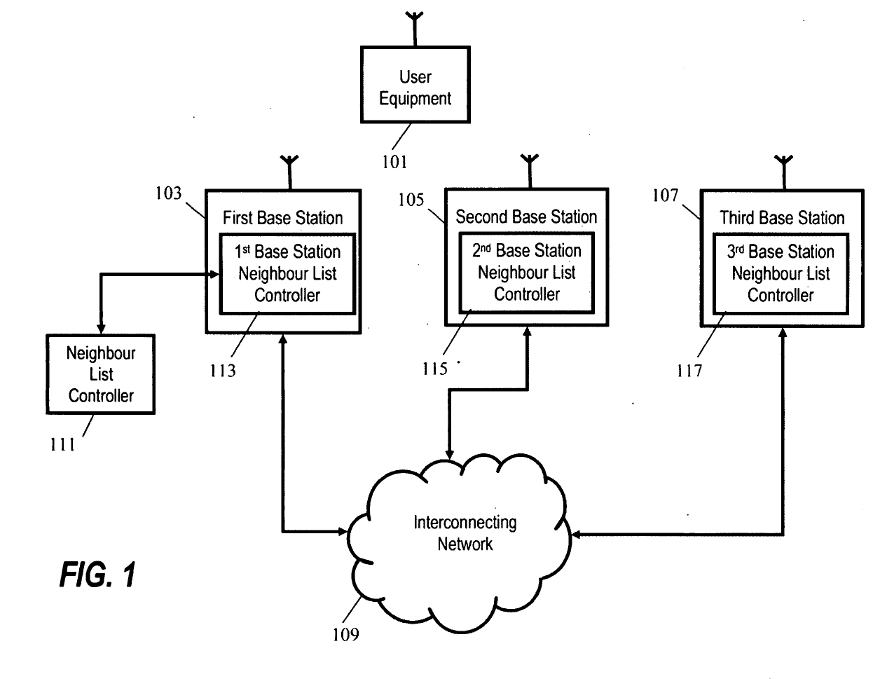

FIG. 1 illustrates an example of a cellular communication system in accordance with some embodiments of the invention. The cellular communication system is specifically a GSM/UMTS cellular communication system which supports a plurality of user equipments. FIG. 1 illustrates a single user equipment 101 and three base stations 103, 105, 107 which are coupled together via an interconnecting network 109.

It will be appreciated that for brevity and clarity, FIG. 1 only illustrates components of the cellular communication system required for the following description and that a practical cellular communication system will typically comprise a large number of base stations each capable of supporting a plurality and potentially large number of user equipments. It will furthermore be appreciated that the interconnecting network 101 represents all other aspects of the fixed segment of the GSM/UMTS communication system including other base stations, Radio Network Controllers RNCs), Mobile Switching Centres (MSCs), Serving and Gateway GPRS (General Packet Radio Service) Support Nodes (SGSN and GGSNs) etc as will be well known to the person skilled in the art.

A user equipment may be any communication entity capable of communicating with a base station (or access point) over the air interface including e.g. a mobile phone, a mobile terminal, a mobile communication unit, a remote station, a subscriber unit, a 3G User Equipment etc. In the example of FIG. 1 the user equipment 101 is a GSM/UMTS multimode mobile phone.

In the system of FIG. 1, the handovers (for active calls and sessions) and reselections (for idle mode user equipments) between different cells are based on the user equipments making measurements of other cells than the cell which is currently supporting the user equipment (directly or indirectly). The cell switch candidates which are measured are based on information transmitted to the user equipments from the base stations.

Specifically, each of the base stations 103-107 broadcasts a neighbour cell list which comprises a set of cells that are potential candidates for handovers and reselections for user equipments supported by the base station 103-107. An idle mode user equipment 101 then proceeds to measure the receive signal level of the cell switch candidates indicated in the neighbour cell list and may proceed to perform an idle mode cell reselection if a more advantageous cell is detected. Similarly, an active mode user equipment 101 will measure signal levels of the candidate cells and report these back to the base station 103-107. Based on the measurement reports, the system may initiate a handover of the user equipment 101 to another cell.

In order to have efficient operation and high performance, it is important that the user equipments measure the appropriate neighbour cells and thus that the possible cell switch candidates accurately reflect the base station deployment and cell layout. In the system of FIG. 1, a centralised neighbour list controller 111 is arranged to determine suitable neighbour lists for a plurality of base stations. These neighbour lists may for example be determined based on a frequency planning operation which may furthermore be based on measurement data gathered from the neighbour cell reporting of the user equipments.

However, in the system, the neighbour list controller 111 is arranged to only provide neighbour lists for base stations belonging to the macro-layer and the micro-layer but not to pico-cell (or femto-cell) base stations. Thus, the neighbour list controller 111 may perform accurate cell planning and control the performance of the system at the higher layers thereby ensuring optimum performance for these layers. However, in addition, the complexity and resource demand of this management is not impacted by the lower layers and specifically are not impacted by a potentially large and dynamically varying number of pico-cells and femto-cells in the system.

In addition to the neighbour list controller 111, each of the base stations 103-107 comprises a base station neighbour list controller 113-117 which is arranged to generate a cell switch candidate list for the corresponding base station 103-107. In the specific example, the cell switch candidate list is a neighbour list but it will be appreciated that in some embodiments the cell switch candidate list may be a list for active user equipments and/or for idle mode user equipments (or may e.g. be a list having different entries for active and idle mode user equipments).

In the example, the first base station 103 is a macro base station and the first base station neighbour list controller 113 of the first base station 103 is coupled to the neighbour list controller 111. In the example, the first base station neighbour list controller 113 may simply receive the macro- and micro-cell neighbour cell list from the neighbour list controller 111 and broadcast these in the first cell supported by the first base station 103. In addition, the first base station neighbour list controller 113 may add any pico- or femto-cells that have been identified by the neighbour list controller 111 or which have been detected by the first base station neighbour list controller 113 as being suitable cell switch candidates for the first cell.

In the example, the second and third base stations 105, 107 are pico-cell base stations which are not directly considered by the neighbour cell generation process of the neighbour list controller 111. Accordingly, the second and third base station neighbour list controllers 115, 117 of the second and third base stations 105, 107 respectively are not directly coupled to the neighbour list controller 111 but rather determine suitable neighbour candidate lists autonomously and independently.

For example, the third base station 107 may be introduced to a live system and it may initially scan the frequency band to detect which other cells are present. This scan may identify e.g. the macro-cell supported by the first base station 103 and accordingly the details for the first base station 103 may be included in the neighbour list generated by the third base station neighbour list controller 117 thereby enabling handovers from the pico-cell of the third base station 107 to the macro-cell of the first base station 103.

Furthermore, the third base station 107 is included in the neighbour list of one or more other base stations thereby enabling handovers into the pico-cell of the third base station 107. Specifically, during an initialisation and configuration process of the third base station 107, the first base station neighbour list controller 113 may be informed of the existence of the third base station 107. For example, the third base station 107 may directly access the first base station 103 by simulating a user equipment. It may then communicate the appropriate details of the third base station 107 causing it to be included in a neighbour list. As another example, the communication may be directly between the third base station 107 and the first base station 103 via the interconnecting network 109. As yet another example, the third base station 107 may send a message to the neighbour list controller 111 indicating that it has been introduced to the system under the macro-cell of the first base station 103. The neighbour list controller 111 may then forward the relevant information to the first base station 103.

In the system of FIG. 1, the user equipment 101 is arranged to transmit previous cell switch candidate data to the currently supporting base station. The previous cell switch candidate data comprises an indication of at least one cell switch candidate for at least one base station supporting the user equipment prior to the current base station, i.e., base station currently supporting the user equipment or base station that the user equipment is in the process of handing over to.

For example, in a specific scenario for the system of FIG. 1, the user equipment 101 may just have completed a handover from the first base station 103 to the second base station 105 (or may be in the process of performing this handover in which case the user equipment 101 may only partially be supported by the second base station 105 when the previous cell switch candidate data is transmitted).

The user equipment 101 may then proceed to generate and transmit a message to the second base station 105 which comprises cell switch candidate data for the macro-cell supported by the first base station 103. Thus, after handing over to the second pico-cell supported by the second base station 105 (or during the handover), the second base station 105 may receive a message from the user equipment 101 which indicates the cell switch candidates for the first base station 103. Thus, the second base station 105 receives additional information which does not only relate to its own neighbour cells but also to neighbour cells of these neighbour cells.

The second base station 105 may then use this information to adapt its own neighbour cell list. For example, the initialisation and configuration of the third base station 107 may result in the third base station being linked to the macro-cell (and thus the first base station 103) and thus the third base station may be included in the neighbour list of the macro-cell. Accordingly, user equipments can handover between the macro-cell and the second pico-cell (pico cell supported by the third base station) but can not initially hand over directly between the pico-cells (i.e. between the second base station 105 and the third base station 107). However, if the pico-cells are adjacent (or partially or fully overlapping), a user of the user equipment 101 may move from the second to the first pico-cell resulting in a handover from the second pico-cell to the macro-cell followed by a handover from the macro-cell to the first pico-cell. The user equipment 101 will then transmit previous cell switch candidate data that includes an identification of the second pico-cell and accordingly, the second base station neighbour list controller 115 may proceed to include the third base station 107 in the neighbour list for the second base station 105. This may allow an automatic detection of the third base station 107 by the second base station 105 and thus enable direct handovers between the two pico-cells.

As another example, the user equipment 101 may initially be supported by the second base station 105 and may receive a neighbour list for this base station including both the first base station 103 and the third base station 107. It may then handover to the macro-cell and transmit previous cell switch candidate data to the first base station 103. This data will include an identification of the third base station 107.

The first base station neighbour list controller 113 may then customise the neighbour list for the user equipment 101 and may specifically include base stations indicated in the previous cell switch candidate data. Specifically, the neighbour list for the user equipment 101 may include the third base station 107. In many practical systems, the number of pico- and femto-cells residing under a given macro-cell may substantially exceed the maximum number of neighbour cells that are allowed and/or which it is practical to measure. Accordingly, only a limited number of underlay cells can be included in the neighbour list and the described approach may allow the pico-cells that are included in the neighbour list for a specific user equipment to reflect the increased probability that a direct handover to a pico-cell is possible if the pico-cell is a neighbour of the pico-cell from which the user equipment has just handed over.

In the specific example of FIG. 1, the cellular communication system is a single homogeneous communication system. However, it will be appreciated that the same principle of a user equipment 101 communicating previous cell switch candidate data may be advantageously applied in a cellular communication system comprising a plurality of different cellular communication (sub)systems.

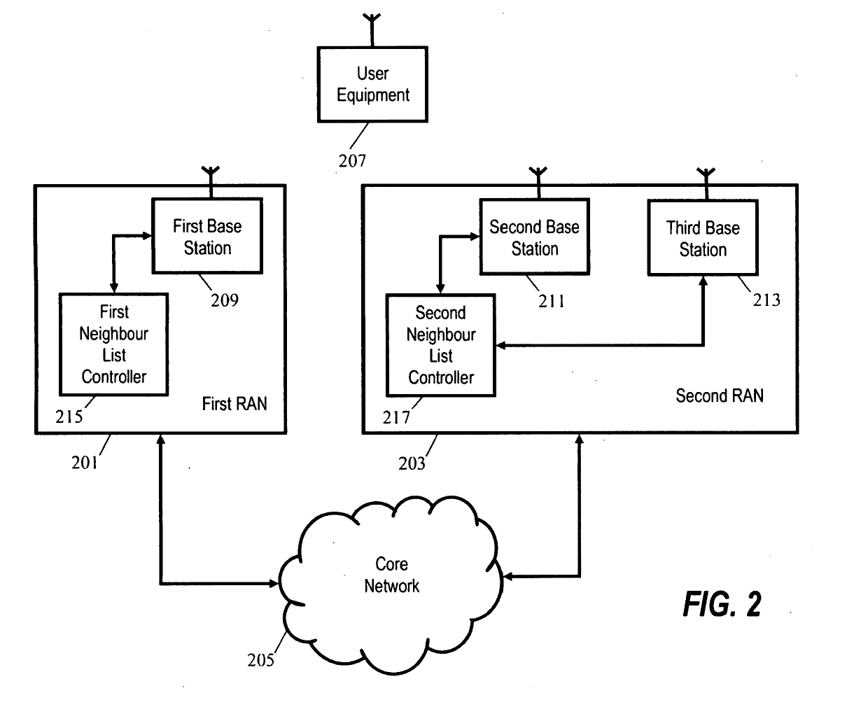

An example of a heterogeneous cellular communication system is shown in FIG. 2. In the system, two different Radio Access Networks (RANs) are illustrated although it will be appreciated that the system may comprise a larger number of RANs. In the example, the two RANs use different technologies and operate in accordance with different Technical Specifications and Standards. In the specific example, the first RAN 201 is a GSM/UMTS communication system whereas the second RAN 203 is an IEEE 802.16 (Wimax™) communication system.

The two RANs 201, 203 are coupled together via a core network 205. It will be appreciated that although the example of FIG. 2 is concerned with a system wherein two independent and different RANs 201, 203 are coupled together via a shared core network, the principles described in the following will be equally applicable to e.g. completely independent systems that do not share any network functionality. In the example, a multi-mode user equipment 207 is capable of being supported by either of the RANs 201, 203 and furthermore intersystem handover and reselections between the RANs 201, 203 may be substantially seamless. Furthermore, the RANs 201, 203 comprise a number of base stations of which FIG. 2 only illustrates a first base station 209 for the first RAN 201 and a second and third base station (access point) 211, 213 for the second RAN 203. It will be appreciated that the RANs typically comprise a large number of base stations as well as many other network elements required or desired for the operation of the RANs. However, for brevity and clarity, FIG. 2 merely illustrates the elements required for the following description.

In the system, the cell switch candidate management is separate for each of the RANs 201, 203 and specifically each of the RANs 201, 203 comprise a neighbour list controller 215, 217 which is arranged to generate cell switch candidate lists for the base stations 209-213 of that RAN. Specifically, the first RAN 201 comprises a first neighbour list controller 215 which generates neighbour lists for base stations 209 of the GSM/UMTS RAN 201 and the second RAN 203 comprises a second neighbour list controller 217 which generates neighbour lists for base stations 211, 213 of the IEEE 802.16 RAN 203.

In the system, the multi-mode user equipment 207 is arranged to transmit previous cell switch candidate data to the base station currently supporting it. Furthermore, the previous cell switch candidate data may relate to cell switch candidates for a different system than the system currently supporting it. For example, the multi-mode user equipment 207 may initially be supported by the second base station 211 of the second RAN 203. It may then perform an intersystem handover to the first base station 209 of the first RAN. The multi-mode user equipment 207 may then transmit previous cell switch candidate data which includes information of the cell switch candidates of the second base station 211. Thus, when the multi-mode user equipment 207 enters the first RAN 201, it not only provides information of which IEEE 802.16 cell it originated from but also which IEEE 802.16 cells are neighbours thereof. This information may be fed to the first neighbour list controller 215 and used to generate suitable cell switch candidate lists for intersystem handovers back to the IEEE 802.16 system.

As a specific example, when the multi-mode user equipment 207 enters the first RAN 201 it may be provided with a cell switch candidate list for the second RAN 203 that includes not only the second base station 211 from which it originated but also the third base station 213 being a neighbour cell of the second base station 211. Thus, based on the previous cell switch candidate data, the first neighbour list controller 215 may generate an intersystem handover candidate list for the multi-mode user equipment 207 which not only includes the second base station 211 but also the third base station 213 (even if the multi-mode user equipment 207 has never been supported by this base station 213). Accordingly, the multi-mode user equipment 207 may directly hand over to the third base station 213 from the first base station 209.

Thus, in the system of FIG. 2, a new message may be defined for a user equipment to transmit to a new network when it transfers to that system. This message can define the neighbor list and/or strongest neighbors that the user equipment was measuring on the previous system prior to the handover. This may include cells on a number of different technologies and access priorities defined by the network for these cells. The new system can then store a record of the previous cell switch candidate data from the user equipment and this can then be used to provide candidate cells to the user equipment when handover to the previous system is required. The information may also be used to define candidate cells for other user equipments leaving the system.

The previous cell switch candidate data may specifically be transmitted to a target base station for a cell switch operation as part of the cell switching process. Specifically, when the user equipment 101 or multi-mode user equipment 207 hands over from the second base station 105, 211 to the first base station 103, 209, the user equipment 101, 207 may transmit a message to the first base station 103, 209 as soon as the handover has been acknowledged by the first base station 103, 209.

Furthermore, in the examples provided previously, the previous cell switch candidate data specifically relates to the cell which has supported the user equipment 101, 207 immediately prior to the base station which receives the previous cell switch candidate data. However, it will be appreciated that in other examples, the previous cell switch candidate data may alternatively or additionally relate to other previously supporting base stations. For example, the user equipment 101, 207 may store the neighbour list/cell switch candidate sets for the past N base stations that have supported the user equipment 101, 207. Each time it attaches or hands over to a new base station, it may then upload previous cell switch candidate data that includes the neighbour list/cell switch candidate sets for the previous N base stations.

It will be appreciated that the additional cell layout information provided by the previous cell switch candidate data may be used differently in different embodiments. For example, in some embodiments it may be used to generate statistical information of the network operation. However, in the specific examples discussed herein, it is used to generate cell switch candidate lists (such as specifically neighbour cell lists).

In some embodiments, the previous cell switch candidate data may be used to generate a user equipment specific cell switch candidate list for the user equipment 101, 207 providing the previous cell switch candidate data. For example, as previously mentioned, in the system of FIG. 1, the macro-cell supported by the first base station 103 may have a very large number pico-cells deployed under it. In such a system it is not feasible for the user equipment 101 to monitor all potential pico-cell handover candidates and accordingly a customised and user specific neighbour cell list may be generated for the individual user equipment. Specifically, the system may include any pico-cell base stations from which the user equipment 101 has handed over as well as any pico-cell base stations which are indicated by the previous cell switch candidate data to be neighbours of a previously supporting base station. This may allow improved handover performance as the pico-cells to which the user equipment 101 may directly handover are increasingly likely to be pico-cells that are currently proximal to the user equipment 101 (specifically the pico-cells which are neighbours of a pico-cell from which the user equipment handed over to the macro-cell may be included).

In some embodiments, the previous cell switch candidate data reported by a user equipment may be used to generate a cell switch candidate list for another user equipment. The generated cell switch candidate list may be, for example, a user specific cell switch candidate list for the second user equipment or may be a common cell switch candidate list for a plurality of user equipments.

For example, for all user equipments handing over to the first base station 103 from the second base station 105 (i.e. from a pico-cell to the macro-cell), previous cell switch candidate data may be received that only indicates neighbour cells of the second base station 105 that meet a criterion. Specifically, the user equipments may be arranged to only include the candidate base stations for which the measured signal level is above a predetermined threshold in the previous cell switch candidate data. The first base station neighbour list controller 113 may then decide whether to include the base station in the neighbour list depending on how frequently the base station is in the previous cell switch candidate data. E.g. if the third base station 107 is included in the previous cell switch candidate data for more than, say, 80% of the user equipments handing over from the second base station 105 to the first base station 103, it is highly likely that the third base station 107 covers an area which is close to or perhaps even overlapping that of the second base station 105. Accordingly, it is relatively probable that a user will move from the pico-cell of the second base station 105 to that of the third base station 107 (possibly via an intermediate region only covered by the first base station 103). Consequently, the third base station 107 may be included in the cell switch candidate list for all user equipments that hand over to the first base station 103 from the second base station 105.

Thus, in some embodiments, a cell switch candidate list may be generated on the basis of previous cell switch candidate data received from one set of user equipments and provided to a second set of user equipments. The first and second sets may have overlapping user equipments but will in some embodiments not be identical.

In some embodiments, the cell switch candidate list may be a cell switch candidate list for a different cell than the one receiving the previous cell switch candidate data. For example, in the system of FIG. 1, the first base station 103 may receive previous cell switch candidate data from user equipments handing over from the second base station 105. This data may indicate that the third base station 107 is a neighbour of the second base station 105. Accordingly, the first base station 103 may communicate this information to the second base station 105 and/or the third base station 107 which may proceed to include the other base station 105, 107 in their neighbour list. Thus, based on the previous cell switch candidate data received at the first base station 103, the neighbour lists of the second base station 105 and/or the third base station 107 may be adapted to allow direct handovers between these base stations 105, 107.

It will be appreciated that the previous cell switch candidate data being provided by the user equipments may allow improved cell switch candidate list management and in particular may allow different cell switch candidate list management domains to be implemented. For example, in the system of FIG. 1, one cell switch candidate list management domain includes the macro- and micro-cell whereas the pico-cell and femto-cells are in a different management domain. Furthermore, in the system of FIG. 2, each cell switch candidate list management domain may correspond to a single RAN or system.

It will also be appreciated that in some embodiments, the previous cell switch candidate data may be stored and used later. For example, the user equipment 101 may provide the previous cell switch candidate data to the first base station 103 when handing over to this as part of an ongoing communication session (such as a circuit switched call or a packet data session). The indication that the third base station 107 is a neighbour of the second base station 105 and is likely to be a possible or even probable future candidate for the user equipment 101 is stored by the first base station neighbour list controller 113.

The current call or session may terminate but the stored information is maintained and linked to the identity of the user equipment 101. If the user equipment 101 at a later stage initiates a new communication session in the macro-cell of the first base station 103, the first base station neighbour list controller 113 may detect this and retrieve the stored previous cell switch candidate data. It may then automatically include the third base station 107 in the cell switch candidate list which is generated at call/session start up for the user equipment 101. Thus, the previous cell switch candidate data obtained as part of a first communication session may be stored and used for a second communication session.

In some embodiments, the previous cell switch candidate data may comprise more information than a simple indication of the cell switch candidates of one or more previous base stations. For example, the previous cell switch candidate data may comprise signal level indications for individual cell switch candidates as measured when the user equipment was supported by the corresponding base station. For example, when the user equipment 101 is served by the second base station 105, it will measure the broadcast pilot signals from the base stations indicated as neighbours of the second base station 105 (and thus including the third base station 107). The measured signal levels may be stored (e.g. following a suitable low pass filtering or averaging) and may be included in the previous cell switch candidate data being transmitted to the first base station 103 after the user equipment 101 has handed over to this. The signal level information may then be used by the first base station neighbour list controller 113 to determine how close the cell of the third base station 107 is likely to be to the cell of the second base station 105. This information may then be used to determine e.g. whether to include the third base station 107 in the neighbour list for the user equipment 101. As a simple example, the cell may only be included if the signal level is above a threshold or a fixed number of pico-cells may be selected as the candidates with the highest measured signal levels.

Also, in some embodiments, the previous cell switch candidate data may include a service capability indication for the cell switch candidates included in the previous cell switch candidate data. For example, the third base station 107 may be able to support only a relatively low data rate and therefore may be suitable for voice calls but not for video calls. In contrast, another neighbour cell of the second base station 105 may support high maximum data rates and may accordingly be suitable for both video and voice calls. The previous cell switch candidate data may e.g. include this capability information (which may e.g. be determined from broadcasts from the individual base stations) and the base station neighbour list controller 113 may use it to determine which base stations to include in the neighbour list for the user equipment 101 when served by the first base station 103. For example, if the user equipment 101 is engaged in a video call, the third base station 107 may not be included in the list whereas the high data rate capable base station may be.

The capability information may be particularly advantageous in a heterogeneous system. For example, a user equipment may handover to a GSM/UMTS system from a cell of an IEEE 802.16 system. However, the possible cell switch candidates of the IEEE 802.16 cell may include other IEEE 802.16 cells but may also include cells of other communication systems including the GSM/UMTS system itself or e.g. IEEE 802.11x systems. The capability of these systems may be substantially different and therefore a significant advantage may often be achievable by taking the capabilities into account.

It will be appreciated that the service capability indication need not be a binary indication of whether the given base station is capable of providing a given service or not, but may for example be related to other parameters such as cost or delay. For example, whereas a GSM system may be able to support a video call at a relatively high cost, an 802.11x system may possibly be able to support it at a very low cost and this may be reflected by the service capability indication. Specifically, the service capability indication may be a relative preference of a given service being supported by a given system.

It will also be appreciated that the service capability indication may be direct or indirect. For example, the service capability indication may simple consist of an indication of the type of system that the given cell switch candidate belongs to.

In some embodiments, the previous cell switch candidate data may comprise an access priority which is assigned to cell switch candidates. The access priority may be an indication of a preference for using the specific cell switch candidate (e.g. for a handover or cell reselection). The access priority may be service dependent such that e.g. different priorities or preferences are provided for different services. As a specific example, for a voice call service, the access priority of a GSM base station may be relatively high whereas the access priority for an IEEE 802.11x system is relatively low. However, for a video call service, the access priority of a GSM base station may be relatively low whereas the access priority for an IEEE 802.11x system is relatively high.

The access priority may for example be provided by the user equipments themselves—for example they may have a preference for using high data rate and low cost systems such as IEEE 802.11x for video calls and high voice quality systems such as UMTS for voice calls. As another example, the access priorities may be provided by the base station from which the user equipments are handing over, e.g. by the access priorities being included in the broadcast cell switch candidate list.

In some embodiments, the previous cell switch candidate data comprises a timing indication for one or more of the cell switch candidates. For example, a measured frame timing offset between a given base station and a cell switch candidate may be measured by the user equipment. When the user equipment subsequently hands over to a new base station, it may include the cell switch candidate and the frame timing offset in the previous cell switch candidate data. The new base station may determine the frame timing offset to the previously serving base station and may use this and the reported frame timing offset to determine the frame timing offset between the new base station and the cell switch candidate. Thus, a timing relation (such as a frame timing offset) may be determined between a serving base station and another base station which may never have been a supporting/serving base station of the user equipment.

The timing information may specifically be used to synchronise the new base station. Thus, the previous cell switch candidate data of the user equipment may be used to synchronise two base stations which may not themselves be neighbours of each other and between which no user equipment may handover directly. This may be highly advantageous in many scenarios and in particular for heterogeneous systems. For example, the cell switch candidate and the new base station may both be Time Division Duplex (TDD) base stations whereas the originally serving base station (prior to the handover) may be a Frequency Division Duplex (FDD) base station. In this case, two potentially otherwise unconnected TDD base stations may be synchronised to each other using an intermediate FDD base station.

It will be appreciated that the improved synchronization is obtained by the user equipment reporting previous cell switch candidate data and is independent of whether this data is also used for cell switch candidate list generation.

In some embodiments, the system may be arranged to invalidate previous cell switch candidate data if a time since the user equipment was supported by the base station for which the cell switch candidate data is provided meets a criterion.

Specifically, previous cell switch candidate data may be considered to be outdated and invalid if the time since the user equipment providing the previous cell switch candidate data was supported by the base station to which the data relates exceeds a threshold. For example, in the system of FIG.1, the previous cell switch candidate data provided by the user equipment 101 when handing over from the second base station 105 to the first base station 103 may be considered valid for a given duration after the handover. However, after this duration, the previous cell switch candidate data may be considered invalid and disregarded for further use.

It will be appreciated that in some embodiments a more gradual invalidation of previous cell switch candidate data may be used such that e.g. a reliability or weighting of the previous cell switch candidate data may be adjusted in response to a duration since the user equipment providing the previous cell switch candidate data was supported by the base station for which the data is provided.

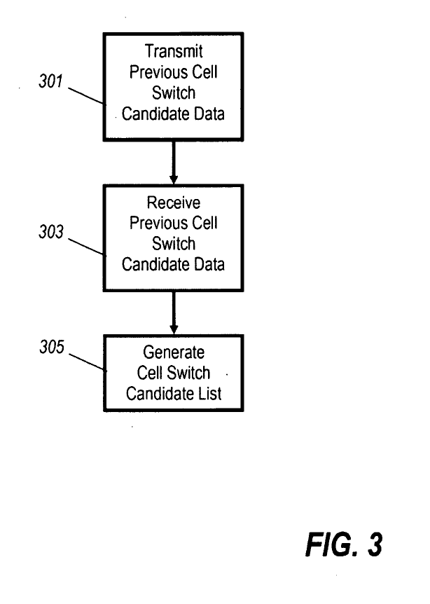

FIG. 3 illustrates a method of operation for a cellular communication system including a first base station supporting user equipments in a first cell and a user equipment being supported in the first cell by the first base station. The method initiates in step 301 wherein the user equipment transmits previous cell switch candidate data to the first base station. The previous cell switch candidate data comprises an indication of at least one cell switch candidate for at least one base station supporting the user equipment prior to the first base station.

Step 301 is followed by step 303 wherein the first base station receives the previous cell switch candidate data transmitted from the user equipment. Step 303 is followed by optional step 305 wherein a cell switch candidate list is generated in response to the previous cell switch candidate data.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A cellular communication system comprising:
a first base station supporting user equipments in a first cell;
a user equipment arranged to transmit previous cell switch candidate data to the first base station when supported in the first cell by the first base station; the previous cell switch candidate data comprising an indication of at least one cell switch candidate for at least one base station supporting the user equipment prior to the first base station; and wherein
the first base station is arranged to receive the previous cell switch candidate data transmitted from the user equipment.

2. The cellular communication system of claim 1 wherein the user equipment is arranged to transmit the previous cell switch candidate data as part of a cell switching process.

3. The cellular communication system of claim 1 wherein the at least one base station is a base station supporting the user equipment immediately prior to the first base station.

4. The cellular communication system of claim 1 further comprising candidate cell means for generating a cell switch candidate list in response to the previous cell switch candidate data.

5. The cellular communication system of claim 4 wherein the cell switch candidate list is a user equipment specific cell switch candidate list for the user equipment.

6. The cellular communication system of claim 4 wherein the candidate cell means is arranged to provide the cell switch candidate list to a second user equipment.

7. The cellular communication system of claim 4 wherein the cell switch candidate list is a cell switch candidate list for a different cell than the first cell.

8. The cellular communication system of claim 4 wherein the first base station and the at least one base station belong to different cell switch candidate list management domains.

9. The cellular communication system of claim 4 wherein the previous cell switch candidate data is associated with a first communication session and further comprising means for storing the previous cell switch candidate data and for determining the candidate cell switch list for a second communication session.

10. The cellular communication system of claim 1 wherein the previous cell switch candidate data comprises a signal level indication for the at least one cell switch candidate when the user equipment is supported by the at least one base station.

11. The cellular communication system of claim 1 wherein the previous cell switch candidate data comprises a service capability indication for the at least one cell switch candidate.

12. The cellular communication system of claim 1 furthermore comprising means for invalidating previous cell switch candidate data for the at least one cell switch candidate if an indication of a time since the user equipment was supported by the at least one base station meets a criterion.

13. The cellular communication system of claim 1 wherein the cellular communication system is a combined communication system comprising a plurality of communication systems and the first base station and the at least one base station belong to different communication systems.

14. The cellular communication system of claim 13 wherein the base station and the at least one base station belong to different radio access networks using different radio access technologies.

15. The cellular communication system of claim 1 wherein the previous cell switch candidate data comprises an access priority assigned to the at least one cell switch candidate.

16. The cellular communication system of claim 1 wherein the previous cell switch candidate data comprises a timing indication for the at least one cell switch candidate.

17. The cellular communication system of claim 16 further comprising means for synchronising the first base station in response to the timing indication.

18. The cellular communication system of claim 1 wherein the user equipment is arranged to select a set of cell switch candidates for inclusion in the previous cell switch candidate data in response to measured signal levels for cell switch candidates of the at least one base station.

19. A user equipment for a cellular communication system including a first base station supporting user equipments in a first cell; the user equipment comprising:
means for transmitting previous cell switch candidate data to the first base station when supported in the first cell by the first base station; the previous cell switch candidate data comprising an indication of at least one cell switch candidate for at least one base station supporting the user equipment prior to the first base station.

20. A method of operation for a cellular communication system including a first base station supporting user equipments in a first cell and a user equipment being supported in the first cell by the first base station; the method comprising:
the user equipment transmitting previous cell switch candidate data to the first base station; the previous cell switch candidate data comprising an indication of at least one cell switch candidate for at least one base station supporting the user equipment prior to the first base station; and
the first base station receiving the previous cell switch candidate data transmitted from the user equipment.
